(19) United States
(12) Patent Application Publication
(10) Pub. No.: US 2003/0139992 A1
(43) Pub. Date: Jul. 24, 2003

(54) Method of creating financial structure for delivering a tax favored financial position

(76) Inventor: Patrick Flanery, Scottsdale, AZ (US)

Correspondence Address: Roger W. Jensen, Roger W. Jensen & Associates, Ltd., 8127 Pennsylvania Circle, Minneapolis, MN, 55438, US

(21) Appl. No.: 10/054,505

(22) Filed: Jan. 22, 2002

(51) Int. Cl. G06F 17/60

(52) U.S. Cl. 705/36

(57) ABSTRACT

A multiple-step method of deferring compensation of an individual, with concurrent deferral of payment of income tax. The method of the invention is especially important, helpful, and applicable to a highly compensated individual.

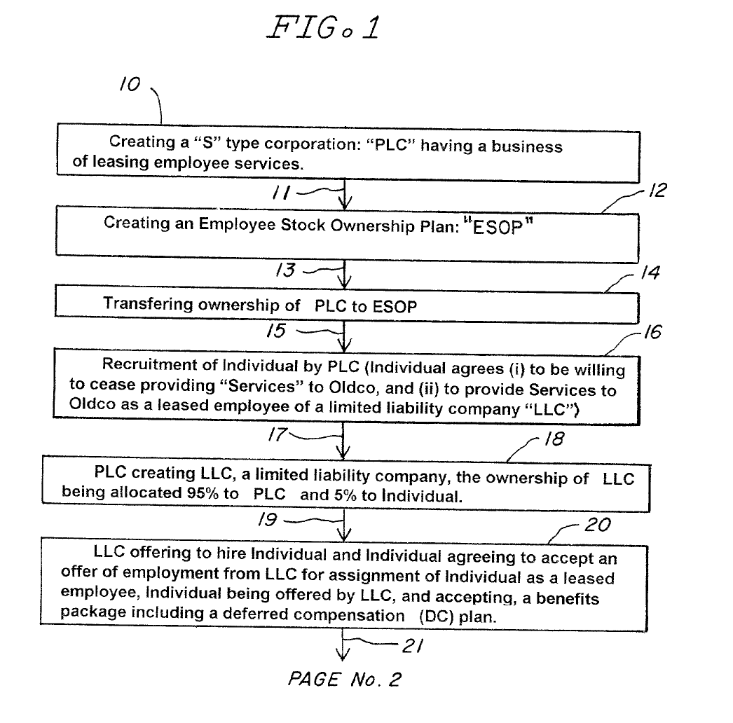

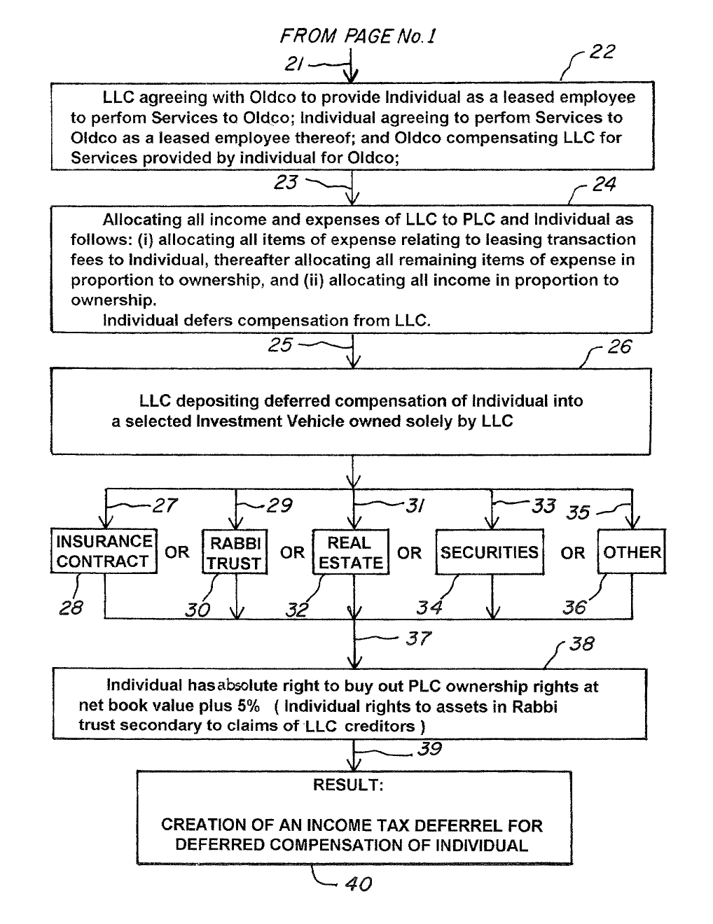

### FIELD OF THE INVENTION

The present invention relates generally to the field of financial planning, and more specifically to a method of deferring compensation of an individual, and thus deferring the payment of income tax on such deferred compensation. The invention is especially important, helpful and applicable to a highly compensated individual such as, by way of an example, a medical doctor who is the sole owner of a medical office, hereinafter “Oldco.” The doctor, hereinafter, “Individual” is an officer and employee of Oldco which also employs a small number of other persons in administrative and medical support positions. Individual is appropriately highly compensated but is not, under prior financial planning scenarios, able to adequately defer compensation and, concurrently, defer the applicable income tax, regard being given to applicable governmental regulations. This results in a current income tax. Deferred compensation is frequently advantageous for reasons well understood by those skilled in financial planning. Another issue is that financial privacy within a small business can be non-existent and, for various reasons, Individual may want the deferring of part or even all of his or her compensation maintained as a private matter.

### BACKGROUND OF THE INVENTION

There are, of course, various prior art financial planning arrangements and tools. Prior methods for sheltering or deferring income of a highly compensated sole owner of a business have had serious shortcomings. First, IRC 401 plans require “qualified plans”; a non-qualified plan is not exempt from tax. A company or business having a qualified plan is required to offer such plan to all employees. In some cases, for various reasons, the owner(s) of the company might not want to include all or some of the employees in the plan. Stated bluntly, as an example, Individual may want only his or her compensation to be deferred on a tax-deferred basis, i.e., not including the other employees.

### SUMMARY OF THE INVENTION

The problems and shortcomings of the prior art financial plans are overcome by the present invention which provides a method of creating a financial structure for a highly compensated individual who is the sole owner of a business. The method advantageously creates the availability of a significant deferral of compensation (and also a deferral and likely reduction of income tax). More specifically, the invention provides a method which facilitates an individual deferring a substantial amount of compensation, which, if not deferred, would be considered current income, and thus subject to income tax for the year of the earned income. However, the invention's method is structured so that the compensation may be deferred, at the election of Individual, without any current income tax. The deferred compensation is taxed only at a later time, as explained below, with the timing controlled by Individual; this could be years after the original deferral and could be at a much more opportune time for Individual for the payment of the required income tax. The deferral of Individual's compensation does not require creating a qualified plan for the other employees of Oldco. There is no requirement for the other employees to have knowledge of the special arrangement for Individual.

The method is managed by a “Parent” leasing company, hereinafter “PLC,” an “S” corporation which is in the business of leasing professional services to professional companies such as Oldco. PLC recruits professionals from small and closely held professional companies by offering and providing employment benefits customarily provided by employee leasing firms, including disability, life, professional malpractice and health insurance, workers compensation, and so forth, together with qualified and non-qualified pension and retirement planning. Due to the relatively large size of PLC, i.e., economies of scale, PLC is able to provide greater benefits at less cost than the prior “smaller” employer is.

The method of this invention, i.e., creating a means for enabling deferred compensation with the attendant income tax deferral involves a sequential series of steps. First, PLC is incorporated as an “S” corporation, as covered by IRS guidelines and regulations. PLC is thus a “pass-through” entity, meaning that it per se is not taxed; income is taxed to the shareholder(s). PLC is in the business of leasing professional employee services. The next step is to create an Employee Stock Ownership Plan “ESOP,” again in conformance with applicable governmental regulations; the ESOP is an IRC 401 employee benefit plan tax exempt under the provisions of IRC 501. The next step is to put the ownership of the “pass-through” entity (S corporation) into the ESOP, i.e., ownership of PLC is transferred to ESOP. Thus, income of PLC is tax exempt.

The next step of the method of this invention is the recruitment of an individual, e.g., “Individual”, who agrees (i) to be willing to cease providing services “Services” to his or her totally owned company, e.g., “Oldco”, and to be willing to provide Services to Oldco as a leased employee of a limited liability company “LLC” which PLC creates as the next step. The ownership of LLC is allocated: 95% to PLC and 05% to Individual. Individual, as the following step, accepts PLC's offer to hire Individual as a leased employee, i.e., Individual agrees to accept employment assignments arranged by PLC and specifically agrees to perform Services at Oldco. The PLC offer to Individual also includes a benefits package comprising various benefits available as selected by Individual. The benefits package includes a deferred compensation (DC) plan. It should be understood that LLC is uniquely linked to Individual and, of course, PLC; PLC will create additional and legally distinct limited liability companies for respective additional leased employees who are individuals similar to Individual.

Then LLC contractually agrees with Oldco to provide Individual as a leased employee to perform Services for Oldco; concurrently Individual agrees to perform Services for Oldco as a leased employee thereof; and concurrently Oldco agrees to compensate LLC for Services provided by Individual for Oldco, the foregoing steps may be conveniently and seamlessly facilitated in a single three party contract.

The method of this invention has the further step of allocating all income and expenses of LLC to PLC and Individual as follows:

(i) allocating all items of expense relating to leasing transaction fees to Individual, and thereafter allocating all remaining items of expense to PLC and Individual in proportion to ownership, and (ii) allocating all income to PLC and Individual in proportion to ownership.

Individual defers compensation from LLC, which deposits such deferred compensation of Individual into an investment vehicle of the Individual's choice. One of the choices, and the preferred choice available to the individual, is to have the deferred compensation deposited into life insurance contract owned solely by LLC with Individual being the named insured. The death benefit of the insurance contract or policy is dedicated to cover deferred compensation liability. The LLC is further characterized by Individual having the absolute right to buy out, from PLC, the entire ownership of PLC in the LLC at a cost equal to the net book value of LLC plus a 5% irrevocable assignment of the death benefit of said life insurance policy.

The insurance choice has a number of advantages. There are, however, other investment vehicle choices available to Individual such as a Rabbi Trust, real estate, securities, or other.

The bottom line result of the method of this invention is a tool which, if selected, can enable the deferral of a significant amount of compensation for an Individual and thus defer and possibly lessen the associated income tax.

### DESCRIPTION OF THE DRAWING

The single drawing FIGURE comprises two sheets which collectively depict a flow chart of the multi-steps of the preferred embodiment of the invention. Page 1 depicts elements 10-21 inclusive and Page 2 depicts elements 21-39 inclusive.

### DETAILED DESCRIPTION OF THE INVENTION

Referring to the first page of the drawing, a highly compensated individual, hereinafter “Individual” (see step 16) is the sole owner of a business “Oldco,” with respect to which Individual is an officer and an employee. Oldco also employs a small number of other persons in administrative and support positions. Individual is appropriately highly compensated and would like to be able to defer part and possibly all of the compensation paid by Oldco to Individual and, most importantly, concurrently defer the payment of income tax on such compensation. The method of this invention provides such an option to Individual.

The multi-step method or process of this invention is managed by a Parent Leasing Company (PLC) created at step 10. PLC is an “S” Corporation, as that form of business entity is defined by IRC. As is well understood, an S corporation is a “pass-through” entity, meaning that it is not taxed on income thereof; such income is taxed to the shareholder(s). PLC is in the business of leasing employee services to companies such as Oldco. PLC recruits professionals from small and closely held companies by offering and providing employment benefits customarily provided by employee leasing firms, including disability, life, professional malpractice and health insurance; workers compensation; and so forth; importantly, PLC also offers and provides qualified and non-qualified pension and retirement planning.

The method flows from step 10 via 11 to step 12, the creation of an Employee Stock Ownership Plan “ESOP,” an IRC 401 employee benefit plan which is tax exempt under the provisions of IRC 501. Step 12 flows via 13 to step 14, the transfer of ownership of PLC to ESOP; the ensuing result is that PLC's income is tax exempt. The generalities of the method set forth solely in steps 10-14 is known to those skilled in the art and has been permissible under applicable laws since Jan. 1, 1998.

The next step in the method is, in general, for PLC to recruit persons for its employee leasing business. Step 16, linked via 15 to prior step 14, is the recruitment by PLC of a specific person, i.e., the aforesaid Individual. As subset of the recruitment, Individual agrees (i) to be willing to cease providing services “Services” to Oldco as an employee thereof, and (ii) to be willing to provide Services to Oldco as a leased employee of a limited liability company formed by PLC. The employee leasing service business of PLC for Individual is provided by PLC creating a limited liability company LLC solely dedicated to business associated with Individual. The creation of LLC is depicted in the drawing as step 18, linked via 17 to prior step 16. PLC typically will have a number of other individual clients/employees; a separate limited liability company similar to LLC will be set up or created by PLC for each of such other client/employees.

A very important aspect of the method of this invention is the ownership of LLC is allocated 95% to PLC and 5% to Individual.

Step 20, linked via 19 to prior step 18, is for LLC to offer to hire Individual as a leased employee (to perform Services at Oldco) and for Individual to agree to perform Services. Closely coupled is the next step 22, linked via 21, wherein LLC enters into an agreement with Oldco to provide Individual as a leased employee to perform Services at Oldco; Individual also contractually agrees to the foregoing. Oldco does not directly compensate Individual or PLC; Oldco compensates LLC for Services performed by Individual. As indicated, the agreements/contracts between PLC, LLC and Individual may be separate documents or a three party agreement.

LLC typically will offer a menu of benefits to Individual including, most importantly, a deferred compensation (DC) plan which Individual will accept in order to enjoy the potential deferral of compensation. Although not directly linked to this invention, but of obvious significance, LLC will also offer other benefits to Individual including disability, life, professional malpractice and health insurance, workers compensation. PLC, in the preferred embodiment of this invention, will supply or otherwise facilitate the provision of the above benefits as selected by Individual; this usually can be done at a lesser cost as compared to Individual being an employee of Oldco.

As indicated, LLC receives income from Oldco; LLC also has expenses, which typically include the payment to PLC a service fee, e.g., 3.5% for services provided by PLC, as well as other expenses.

As indicated in step 24, linked via 23 to prior step 22, all of the income and expenses of LLC are allocated to PLC and Individual. All of LLC expenses relating to leasing transaction fees, e.g., the service fee paid to PLC, are allocated to Individual. All remaining expenses of LLC are allocated to PLC and Individual in proportion to ownership. All of LLC income is allocated to PLC and Individual in proportion to ownership.

Proceeding to the next step 26, via 25, and pursuant to Individual's choice and directive, LLC defers compensation payable to Individual and deposits such deferred compensation into a selected investment vehicle. The recommended choice of an investment vehicle is a life insurance contract/policy (step 28 via 27); such policy is solely owned by LLC, the named insured is Individual, and the death benefit is dedicated to cover deferred compensation liability. An additional option for this choice is to have the insurance contract or policy owned by a Rabbi trust; this would make a subsequent buy out subject to claims by creditors of LLC. An advantage of the insurance choice is that, during the term of the method, the Individual may borrow money, as a function of the cash value of the insurance policy/contract without taxation at the time of the borrowing.

Other choices include a Rabbi Trust 29 via 28; real estate 32 via 31; securities 34, e.g., stocks, bonds, etc., via 33 or other items of real or personal property 36 via 35.

Very importantly, Individual has the absolute right, for all of the choices, to buy out from PLC the entire 95% ownership of PLC in LLC. This is indicated in the drawing by step 38 via 37.

For the insurance choice 38, the buy out is at a cost equal to the net book value of LLC plus a 5% irrevocable assignment to PLC of death benefit of the aforesaid insurance contract/policy. The 5% fee represents income for PLC. Likewise, for the other choices, the buy out is at a cost equal to the net book value of the asset plus 5%. Any choice involving the utilization of a Rabbi trust results in the pay out being secondary to claims, if any, of creditors of the LLC.

The bottom line result of the invention is depicted at 40, linked via 39 to 38, as the creation of a method for the deferral of compensation for an individual with the associated deferral of payment of income tax which, depending on circumstances, can be extremely beneficial for the taxpayer.

It will be understood that a series of transactions over a period of time involving the above method are likely. In each case, a new LLC is created by PLC for Individual.

An example of the method is to assume Individual would receive an annual compensation from Oldco of $100,000 as an employee. If Individual elects to use this invention, then the $100,000 is paid by Oldco to LLC. LLC then will pay a fee of, say, $3,500 to PLC (a 3.5% fee being appropriate, regard being given to the services provided by PLC). The balance or net amount of $96,500 then will be paid by LLC into the insurance policy or any of the other choices of investment vehicles. When Individual wants to withdraw money (which may be at any later point of time as selected by Individual), Individual notifies PLC, pursuant to Individual's absolute right, of Individual's choice to “buy out” PLC. PLC must liquidate the assets as above described and all funds, less fees, are payable to Individual.

While the preferred embodiment of the invention has been illustrated, it will be understood that variations may be made by those skilled in the art without departing from the inventive concept. Accordingly, the invention is to be limited only by the scope of the following claims.

1. A method of creating a financial structure for an individual, hereinafter “Individual” for the purpose of delivering a tax favored financial position to Individual, said Individual being characterized by being highly compensated by a preexisting business entity, hereinafter “Oldco”, the ownership and control of which is by Individual, the method comprising the steps of:
a. creating an “S” type corporation, hereinafter “PLC,” and having a purpose of engaging in the business of leasing employee services;
b. creating an Employee Stock Ownership Plan, hereinafter “ESOP”;
c. transferring ownership of PLC to ESOP;
d. recruitment of Individual by PLC whereby Individual agrees (i) to be willing to cease providing services, hereinafter “Services,” to Oldco, and (ii) to provide Services to Oldco as a leased employee of a limited liability company, hereinafter “LLC”;
e. PLC creating LLC, a limited liability company, the ownership of LLC being allocated 95% to PLC and 5% to Individual;
f. LLC offering to hire Individual and Individual agreeing to accept an offer of employment from LLC for assignment of Individual as a leased employee, Individual being offered by LLC, and accepting, a benefits package including a deferred compensation (DC) plan;
g. LLC agreeing with Oldco to provide Individual as a leased employee to perform Services to Oldco; Individual agreeing to perform Services to Oldco as a leased employee thereof; and Oldco compensating LLC for Services provided by Individual for Oldco;
h. allocating all income and expenses of LLC to PLC and Individual as follows: (i) allocating all items of expense relating to leasing transaction fees to Individual, thereafter allocating all remaining items of expense in proportion to ownership, and (ii) allocating all income in proportion to ownership;
i. Individual deferring compensation from LLC and LLC depositing deferred compensation of Individual into an investment vehicle selected by Individual; and
said method creating an income tax deferral for said deferred compensation of said Individual.

2. The method of claim 1 wherein said investment vehicle is a life insurance policy.

3. The method of claim 2 wherein said insurance policy specifies Individual as the named insured, and with the death benefit being dedicated to cover deferred compensation liability, and LLC is structured so that Individual has the absolute right to buy out, from PLC, PLC's entire ownership of LLC at a cost equal to the net book value of LLC plus a irrevocable assignment of said death benefit.

4. The method of claim 3 wherein said insurance policy is held in a Rabbi trust.

5. The method of claim 1 where said investment vehicle is a non-qualified, deferred compensation plan.

6. The method of claim 1 wherein said investment vehicle is an asset held in trust by a Rabbi trust.
